(19) United States
(12) Patent Application Publication
(10) Pub. No.: US 2023/0023318 A1
(43) Pub. Date: Jan. 26, 2023

(54) LOW PRESSURE WASHER NOZZLE TIP

(71) Applicants: Dan Swanson, Chicago, IL (US); Karolina Stus, Chicago, IL (US)

(72) Inventors: Dan Swanson, Chicago, IL (US); Karolina Stus, Chicago, IL (US)

(21) Appl. No.: 17/869,176

(22) Filed: Jul. 20, 2022

Related U.S. Application Data
(60) Provisional application No. 63/224,606, filed on Jul. 22, 2021.

(51) Int. Cl. B05B 15/658; B05B 1/14

(52) U.S. Cl. CPC B05B 15/658; B05B 1/14

(57) ABSTRACT

A low pressure washer nozzle tip is provided. The low pressure washer nozzle tip has an angled tip with multiple openings and a corresponding retaining nut. The nozzle tip is secured to the retaining nut and wherein both are removably secured to a shaft of a pressure washer gun. The tip of the nozzle is angled at approximately a one hundred to a one-hundred and five-degree axis with respect to a main shaft of the pressure washer.

### REFERENCE TO RELATED APPLICATIONS

This application claims priority to U.S. Provisional Application No. 63/224,606 titled “LOW PRESSURE WASHER NOZZLE TIP” which was filed on Jul. 22, 2021, the entire contents of which are incorporated by reference herein.

### BACKGROUND OF THE INVENTION

A low pressure washer nozzle tip is provided. The low pressure washer nozzle tip has an angled tip with multiple openings and a corresponding retaining nut. The nozzle tip is secured to the retaining nut and wherein both are removably secured to a shaft of a pressure washer gun. The tip of the nozzle is angled at approximately a one hundred to a one-hundred and five-degree axis with respect to a main shaft of the pressure washer.

Nozzles for pressure washers are known. For example, U.S. Pat. No. 8,590,814 to Gilpatrick discloses a nozzle for use with a sprayer, such as a spray gun for a pressure washer or a garden hose system, includes a body, which has an inlet for receiving a pressurized flow of water. The nozzle further includes first and second outlets, and first and second passages. The first and second outlets are formed in an end of the body. The first passage extends between the inlet and the first outlet, and the second passage extends between the inlet and the second outlet. The first and second passages are substantially straight and parallel to one another. During operation of the nozzle, the pressurized flow of water from the inlet is split, passes through the first and second passages, and exits the body from the first and second outlets.

Further, U.S. Pat. No. 8,056,834 to Gardner discloses a cylindrical housing defining a fluid flow path therethrough about a longitudinal axis and a first finger mounted to a first end portion of the housing comprising a wedge disposed on an outer surface of the first finger. A hollow shroud is coaxially disposed around the housing and longitudinally movable with respect to the housing. An outlet aperture is disposed in fluid communication with the fluid flow path, and a ramp disposed within an internal surface of the shroud and engageable with the wedge.

However, these patents fail to describe a low pressure washer nozzle tip which is easy to use. Further, these patents fail to provide for a low pressure washer nozzle tip which allows a user to pressure wash items, such as a car engine, which typically have a confined space to receive the cleaning instrument.

### SUMMARY OF THE INVENTION

A low pressure washer nozzle tip is provided. The low pressure washer nozzle tip has an angled tip with multiple openings and a corresponding retaining nut. The nozzle tip is secured to the retaining nut and wherein both are removably secured to a shaft of a pressure washer gun. The tip of the nozzle is angled at approximately a one hundred to a one-hundred and five-degree axis with respect to a main shaft of the pressure washer.

An advantage of the present low pressure washer nozzle tip is that the present low pressure washer nozzle tip is light-weight.

Another advantage of the present low pressure washer nozzle tip is that the present low pressure washer nozzle tip is maneuverable in tight locations, like a car engine.

Still another advantage of the present low pressure washer nozzle tip is that the present low pressure washer nozzle tip is durable.

Yet another advantage of the present low pressure washer nozzle tip is that the present low pressure washer nozzle tip allows a fluid to exit the nozzle at approximately 40-60 psi.

And another advantage of the present low pressure washer nozzle tip is that the present low pressure washer nozzle tip has an angled tip opening of between one hundred and one hundred and five degrees.

For a more complete understanding of the above listed features and advantages of the low pressure washer nozzle tip reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates an exploded view of the entire low pressure washer nozzle tip, including the handle.

FIG. 2 illustrates a cross-sectional view of the low pressure washer nozzle tip of the present device.

FIG. 3 illustrates a side view of the present low pressure washer nozzle tip in use wherein water is being expelled from the nozzle tip.

FIG. 4 illustrates a cross sectional view of the nozzle of the present device separated from the retaining nut of the present device.

FIG. 5 illustrates a front view of the tip of the nozzle of the present device.

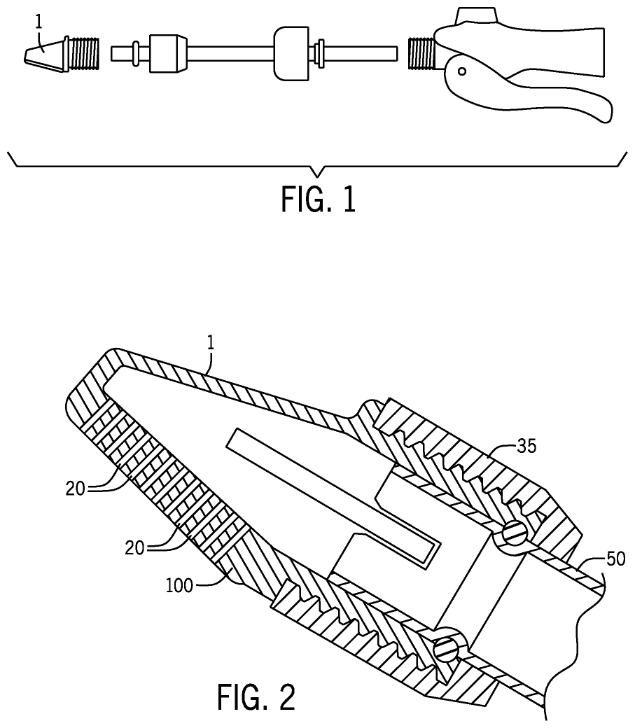

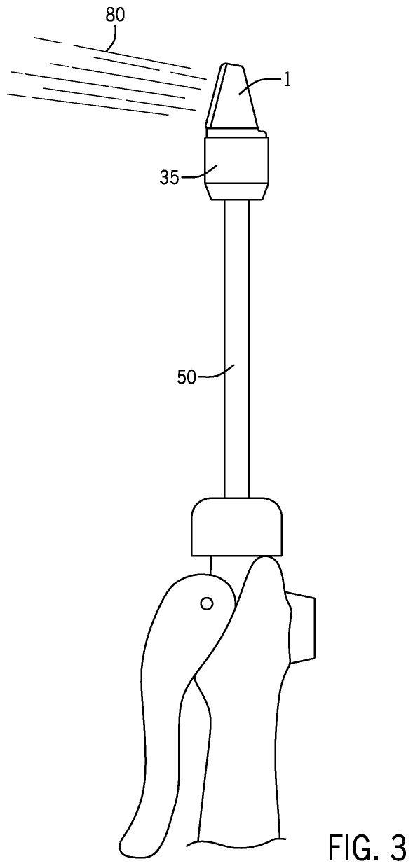

### DETAILED DESCRIPTION OF THE PREFERRED EMBODIMENTS

A low pressure washer nozzle tip is provided. The low pressure washer nozzle tip has an angled tip with multiple openings and a corresponding retaining nut. The nozzle tip is secured to the retaining nut and wherein both are removably secured to a shaft of a pressure washer gun. The tip of the nozzle is angled at approximately a one hundred to a one-hundred and five-degree axis with respect to a main shaft of the low pressure washer.

Referring now to the figures, in an embodiment a low pressure washer nozzle tip 1 is provided. The nozzle 1 is preferably made of a durable material such as a durable plastic or metal. The nozzle 1 has a first end 2 and a second end 3. An opening 4 at the second end 3 allows the nozzle 1 to receive a main shaft 50 of a pressure washer gun.

The first end 2 of the nozzle 1 may be conical in shape having a smaller diameter 5 at the terminal tip 2 than the diameter 6 at the base of the conical tip. As a result, a fluid 80 (such as air or liquid) is forced to flow in a predetermined direction out openings 20 (as discussed below) as a result of the conical shape of the tip of the nozzle 1.

The exterior side 7 of the nozzle 1 may have a threaded member 8 which begins at the location where the conical shape ends. The exterior side 7 is generally cylindrical in shape, having a consistent diameter. The threaded member 8 of the external side 7 of the nozzle 1 receives a corresponding threaded member 30 of a retaining nut 35.

In an embodiment, one extended generally rectangular rim 100 is located on the nozzle tip 1. The extended generally rectangular rim 100 may have a plurality of openings 20 which allow the liquid 80 to pass from a hollow interior 75 of the nozzle 1 to the exterior of the nozzle 1. The openings 20 of the extended generally rectangular rim 100 of the nozzle 1 are preferable parallel to each other and extend approximately one hundred to one hundred and five degrees with respect to an axis line 130 of the shaft 50. Preferably, the openings 20 extend from one hundred and three degrees with respect to the axis 130 of the main shaft 50. The figures illustrate twelve openings 20 extending from the nozzle 1; however, a greater or fewer of openings 20 may be present on the nozzle 1 for expelling the fluid 80.

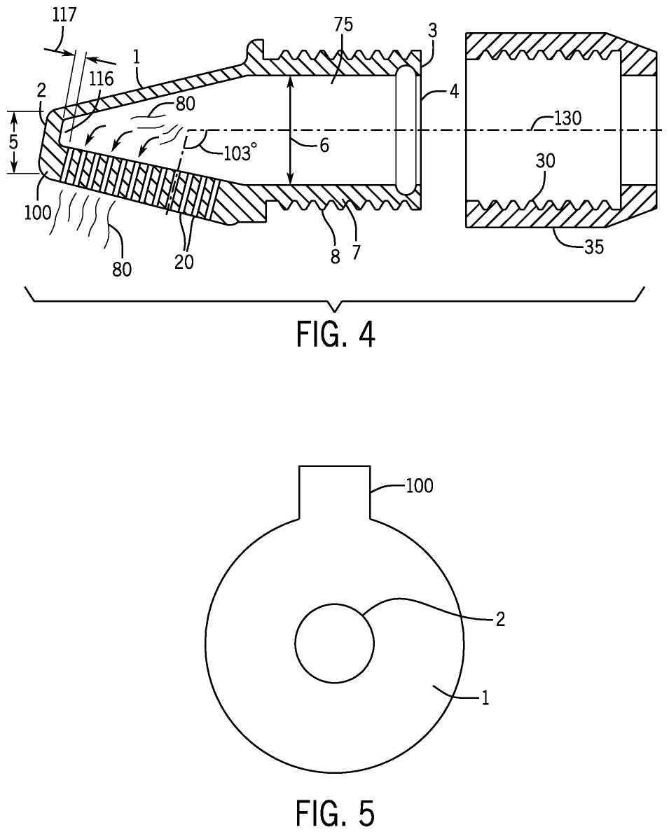

In an embodiment, the front portion of the nozzle 1 may have a dead zone 116. The dead zone 116 may be located between the distal most interior wall of the nozzle 1 and the very first fluid exit opening 20 of the nozzle tip 1. The dead zone 116 may have a length 117 defined by the distance between the distal most interior wall (opposite #2 in FIG. 4) of the nozzle 1 to the first fluid exit opening 20 of the nozzle tip 1. By moving the first fluid exit opening 20 away from the distal interior wall of the tip 1, the dead zone 116 allows the fluid 80 to accumulate at the distal interior wall of the tip 1 and then more effectively exit the openings 20 in a more consistent and at an optimal pressure compared to a nozzle tip having the very first opening directly at the distal interior wall. In one embodiment, the length 117 of the dead zone 116 is at least greater than the width of each individual opening 20.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A low pressure washer nozzle tip system comprising:
a nozzle tip having an exterior surface and an interior surface and a generally hollow interior;
a retaining nut;
a securing device on the nozzle tip and a securing device on the retaining nut wherein the securing device of the nozzle tip and the securing device of the retaining nut correspondingly mate with each other and secure the retaining nut to the nozzle tip;
at least a first fluid exit opening on the nozzle tip wherein the first fluid exit opening of the nozzle tip allows for the passage of a fluid from the generally hollow interior of the nozzle tip out of the nozzle tip through the first fluid exit opening;
an axis line within the generally hollow interior of the nozzle tip wherein the axis line is parallel to a side wall of the nozzle tip; and
wherein the first fluid exit opening of the nozzle tip is at an angle with respect to the axis line of the generally hollow interior of the nozzle tip.

2. The low pressure washer nozzle tip system of claim 1 wherein the angle of the fluid exit opening to the axis line is between one hundred and one hundred and five degrees.

3. The low pressure washer nozzle tip system of claim 1 wherein the nozzle tip is cone-shaped at a terminal end of the nozzle tip.

4. The low pressure washer nozzle tip system of claim 1 further comprising:
a second fluid exit opening of the nozzle tip wherein the second fluid opening of the nozzle tip is parallel to the first fluid exit opening of the nozzle tip.

5. The low pressure washer nozzle tip system of claim 1 further comprising:
an extended generally rectangular rim of the nozzle tip wherein the first fluid exit opening of the nozzle tip is located within the extended generally rectangular rim of the nozzle tip.

6. The low pressure washer nozzle tip system of claim 1 wherein the securing device of the retaining nut and the securing device of the nozzle tip are threaded members which interlock with each other.
